(19) United States
(12) Patent Application Publication
(10) Pub. No.: US 2026/0341698 A1
(43) Pub. Date: Oct. 29, 2026

(54) LITHIUM METAL BATTERY AND A METHOD FOR PRODUCING LITHIUM METAL USED IN A LITHIUM METAL NEGATIVE ELECTRODE

(71) Applicants: HYUNDAI MOTOR COMPANY, Seoul (KR); KIA CORPORATION, Seoul (KR); IUCF-HYU (Industry-University Cooperation Foundation Hanyang University), Seoul (KR)

(72) Inventors: Dong Hyun Lee, Hwaseong-si (KR); Ji Yong Lee, Hwaseong-si (KR); Sangheon Lee, Hwaseong-si (KR); Eunji Kwon, Hwaseong-si (KR); Samuel Seo, Hwaseong-si (KR); Yeonjong Oh, Hwaseong-si (KR); Jiho Lim, Hwaseong-si (KR); Sangsu Lee, Hwaseong-si (KR); Kyoung Han Ryu, Hwaseong-si (KR); Kyuju Kwak, Hwaseong-si (KR); Dong-Won Kim, Seoul (KR); Ji-Wan Kim, Seongnam-si (KR); Yeon-A Kim, Seoul (KR); Heesu Kim, Seoul (KR)

(73) Assignees: HYUNDAI MOTOR COMPANY, Seoul (KR); KIA CORPORATION, Seoul (KR); IUCF-HYU (Industry-University Cooperation Foundation Hanyang University), Seoul (KR)

(21) Appl. No.: 19/459,882

(22) Filed: Jan. 26, 2026

(30) Foreign Application Priority Data
Apr. 28, 2025 (KR) 10-2025-0055406

(51) Int. Cl. H01M 4/525; H01M 4/02; H01M 4/04; H01M 4/36; H01M 4/38; H01M 4/62

(52) U.S. Cl. CPC H01M 4/525; H01M 4/0404; H01M 4/366; H01M 4/382; H01M 4/622; H01M 2004/021; H01M 2004/027; H01M 2004/028

(57) ABSTRACT

A lithium metal battery and a method for producing lithium metal used in the lithium metal negative electrode. The lithium metal battery includes a lithium metal negative electrode integrated with a porous polymer support film that supports an additive lithium salt.

### CROSS-REFERENCE TO RELATED APPLICATION

This application claims priority to and the benefit of Korean Patent Application No. 10-2025-0055406 filed with the Korean Intellectual Property Office on Apr. 28, 2025, the entire contents of which are incorporated herein by reference.

### TECHNICAL FIELD

The present disclosure relates to a lithium metal battery including a lithium metal negative electrode integrated with a polymer support film for a lithium metal battery, and a method for producing lithium metal used in the lithium metal negative electrode.

### BACKGROUND

Electric vehicle may employ high-capacity batteries that surpass the capacities of lithium ion batteries and accordingly, negative and positive electrode materials with high energy density and high energy density and long-term stability of the lithium metal batteries are desired.

Accordingly, lithium metal, which has a high capacity per unit weight of 3,860 mAh/g and a low standard electrode potential (−3.04 V vs normal hydrogen electrode), is attracting attentions as a negative electrode material for rechargeable lithium batteries.

The lithium metal batteries are rechargeable batteries using the lithium metal as a negative electrode material, and the lithium metal, which has 10 times higher specific capacity than graphite used as a negative electrode for the rechargeable lithium batteries but a low reduction potential, is a promising material as a negative electrode for high energy-density rechargeable batteries. Various studies are being conducted on actually using the lithium metal as a negative electrode material to commercialize these lithium metal batteries.

However, a lithium negative electrode may grow lithium dendrites in the form of a resin during the charge and discharge process, and the lithium dendrites may generate a loss of the lithium negative electrode, thereby not only deteriorating capacity and cycle-life characteristics of the batteries but also causing a short circuit of negative and positive electrodes, which lead to safety issues. In addition, high reactivity of the lithium metal causes decomposition of a liquid electrolyte, forming an unstable insulating film with low mechanical strength and high ion resistance on the lithium negative electrode surface. The unstable film may not only suppress additional decomposition of the liquid electrolyte but also impede conduction of lithium ions, resultantly deteriorating capacity and cycle-life characteristics of the batteries.

In order to solve this problem, various studies such as coating a ferroelectricity polymer on the lithium surface to suppress the lithium dendrite growth, applying a chemical reaction to dissociate a large amount of a substance whose use is limited due to its low solubility in a carbonate-based electrolyte, discovering an electrolyte composition and an additive for lithium metal batteries to form a stable film on the lithium metal surface, and the like have been conducted to improve characteristics of lithium metal batteries through modification of the lithium negative electrode surface and an electrolyte.

In other words, in order to commercialize the lithium metal batteries, active studies are being conducted by adding a polymer film in the lithium metal batteries and diversifying and optimizing the composition of an electrolyte such as a solvent, a lithium salt, an additive, and the like.

However, the studies of adding a polymer film capable of suppressing the lithium dendrite growth within the lithium metal batteries have disadvantages of deteriorating lithium ionic conductivity depending on morphology of the polymer film and not completely suppressing the lithium dendrite growth due to mechanical properties of a polymer.

In addition, the studies of exploring a novel composition of an electrolyte for the lithium metal batteries through research on solvents, lithium salts, additive amounts, and the like of the electrolyte have disadvantages of limited types of lithium salts and additives, whose solubility significantly varies depending on the solvents of the electrolyte. In particular, when the additive lithium salts continuously consumed during the lithium metal battery operation are included in the electrolyte composition, after the additive lithium salts are all consumed, the capacity characteristics and cycle-life characteristics may be rapidly deteriorated.

The statements in this Background section merely provide background information related to the present disclosure and may not constitute prior art.

### SUMMARY

An aspect of the present disclosure provides a method for producing lithium metal integrated with a polymer support film storing an additive lithium salt capable of improving the performance of a lithium metal battery, and a lithium metal battery including the lithium metal produced by the method as a lithium metal negative electrode.

A lithium metal battery according to an embodiment includes: a positive electrode; a lithium metal negative electrode opposite to the positive electrode; and the separator between the positive electrode and the negative electrode. The lithium metal negative electrode is integrated with a porous polymer support film that supports an additive lithium salt.

The additive lithium salt may include at least one of LiNO₃, lithium difluoro(oxalate)borate (LiDFOB), LiBOB(Lithium bis(oxalato)borate), LiPO₂F₂, LiPF₆, LiBF₄, LiN(SO₂F)₂, LiN(SO₂C₂F₅)₂, LiCF₃SO₃, LiC₄F₉O₃, LiC₆H₅SO₃, LiSCN, LiB(C₂O₄)₂, LiDFOP(Lithium difluoro(bisoxalato)phosphate), or any combination thereof.

The porous polymer support film may further include a polymer, and the polymer may include at least one of poly(vinylidene fluoride-hexafluoropropylene) copolymer (PVdF-HFP), polyvinylidene fluoride (PVdF), polytetrafluoroethylene (PTFE), polymethyl methacrylate (PMMA), polyethylene oxide (PEO), polypropylene (PP), polyimide (PI), polyamideimide (PAI), polystyrene (PS), polyvinyl chloride (PVC), polyetheretherketone (PEEK), polyestersulfone (PES), or any combination thereof.

The porous polymer support film may have a thickness of less than or equal to 5 μm.

The additive lithium salt may be included in an amount in a range of 2 wt % to 20 wt % based on the total amount (100 wt %) of the porous polymer support film.

The lithium metal negative electrode may have a thickness in a range of 5 μm to 200 μm.

The lithium metal negative electrode integrated with the porous polymer support film that supports the additive lithium salt may include: a current collector; a lithium metal layer on the current collector; and the porous polymer support film that supports the additive lithium salt and is coated on the surface of the lithium metal layer. The lithium metal layer and the porous polymer support film may be integrated.

The lithium metal layer may have a thickness thicker than the current collector, and the current collector may have a thickness thicker than the porous polymer support film.

The additive lithium salt may include a first additive lithium salt and a second additive lithium salt. The first additive lithium salt may include LiNO₃. The second additive lithium salt may include at least one of LiDFOB, LiBOB, LiPO₂F₂, LiPF₆, LiBF₄, LiN(SO₂F)₂, LiN(SO₂C₂F₅)₂, LiCF₃SO₃, LiC₄F₉O₃, LiC₆H₅SO₃, LiSCN, LiB(C₂O₄)₂, LiDFOP, or any combination thereof. The first additive lithium salt may be included in a greater amount than the second additive lithium salt.

The first additive lithium salt and the second additive lithium salt may be included in a weight ratio of 3:1 to 5:1.

The positive electrode may include a positive electrode active material, and the positive electrode active material may include at least one of LiCoO₂, LiNiₓCo_{y}Mn_{z}O₂ (x, y, and z are each independently real numbers from 0 to 1, where x+y+z=1), LiNiₓCo_{y}Al_{z}O₂ (x, y, and z are each independently real numbers from 0 to 1, where x+y+z=1), LiFePO₄, sulfur, or any combination thereof.

The positive electrode active material may include LiNiₓCo_{y}Mn_{z}O₂ (x, y, and z are each independently real numbers from 0 to 1, 0.8≤x<1, x+y+z=1), LiNiₓCo_{y}Al_{z}O₂ (x, y, and z are each independently real numbers from 0 to 1, 0.8≤x<1, x+y+z=1), or a combination thereof.

A method for producing lithium metal integrated with a porous polymer support film that supports an additive lithium salt according to another embodiment includes: mixing an organic solvent, a polymer, and an additive lithium salt to obtain a polymer solution; coating the polymer solution on a lithium metal surface; and drying the polymer solution coated on the lithium metal surface.

The additive lithium salt and the polymer in the porous polymer support film may be as described above.

The polymer solution may be coated on the lithium metal surface to a thickness in a range of 30 μm to 80 μm.

The additive lithium salt may be included in an amount in a range of 2 wt % to 20 wt % based on the total amount (100 wt %) of the polymer solution.

The additive lithium salt includes a first additive lithium salt and a second additive lithium salt. The first additive lithium salt may include LiNO₃. The second additive lithium salt may include at least one of LiDFOB, LiBOB, LiPO₂F₂, LiPF₆, LiBF₄, LiN(SO₂F)₂, LiN(SO₂C₂F₅)₂, LiCF₃SO₃, LiC₄F₉O₃, LiC₆H₅SO₃, LiSCN, LiB(C₂O₄)₂, LiDFOP, or any combination thereof. The first additive lithium salt may be included in a greater amount than the second additive lithium salt.

The first additive lithium salt and the second additive lithium salt may be included in a weight ratio of 3:1 to 5:1.

The organic solvent and additive lithium salt may be included in a weight ratio of 1:1.

Mixing the organic solvent, polymer and additive lithium salt may be performed at a temperature in a range of 30 °C to 50 °C.

Drying the polymer solution coated on the lithium metal surface may be performed at a temperature in a range of 80 °C to 100 °C under a vacuum condition for 6 to 24 hours.

A lithium metal battery including a lithium metal negative electrode integrated with a porous polymer support film that supports an additive lithium salt according to an embodiment may significantly improve cycle-life characteristics of the lithium metal battery by continuously dissolving and electrochemically acting a trace amount of lithium salt even in a solvent having very low solubility.

### BRIEF DESCRIPTION OF THE DRAWINGS

FIG. 1 is a schematic view showing a process for manufacturing a lithium metal negative electrode integrated with a porous polymer support film loaded with an additive lithium salt according to an embodiment.

FIG. 2 is a scanning electron microscope (SEM) photograph showing the microstructure of the polymer film used in Comparative Example 1.

FIG. 3 shows energy dispersive X-ray spectroscopy (EDX) mapping photographs showing the microstructure of the polymer film used in Comparative Example 1.

FIGS. 4 and 5 are scanning electron microscope (SEM) photographs showing the microstructure of the polymer support film used in Example 4, respectively.

FIG. 6 shows an energy dispersive X-ray spectroscopy (EDX) mapping photographs showing the microstructure of the polymer support film used in Example 4.

FIGS. 7 and 8 are scanning electron microscope (SEM) photographs showing the microstructure of the polymer support film used in Example 6, respectively.

FIG. 9 shows an energy dispersive X-ray spectroscopy (EDX) mapping photographs showing the microstructure of the polymer support film used in Example 6.

FIG. 10 is a graph showing the linear scanning potential curves of the cells according to Comparative Example 3 and Example 8.

FIG. 11 is a graph of cyclic voltammetry curves of cells according to Comparative Example 3 and Example 8.

FIG. 12 is a graph of the alternating current (AC) impedance of cells according to Comparative Example 2 and Example 7.

FIGS. 13 and 14 are scanning electron microscope (SEM) photographs showing the microscopic morphology of a lithium metal negative electrode in a charged state of a cell according to Comparative Example 4, respectively.

FIGS. 15 and 16 are scanning electron microscope (SEM) photographs showing the microscopic morphology of a lithium metal negative electrode in a charged state of a cell according to Example 9, respectively.

FIGS. 17A-17D are graphs showing the X-ray photoelectron spectrum and elemental fractions revealed in X-ray photoelectron spectroscopy analysis of the surface of the lithium negative electrode in the state of charge of the cell according to Comparative Example 4, respectively.

FIGS. 18A-18D are graphs showing the X-ray photoelectron spectrum and elemental fractions revealed in X-ray photoelectron spectroscopy analysis of the surface of the lithium negative electrode in the state of charge of the cell according to Example 9, respectively.

FIGS. 19A-19C are graphs showing the amount of lithium nitrate remaining in a polymer support film according to the progress of the cell cycle according to Example 9, wherein FIG. 19A is before cycling, FIG. 19B is after formation cycle, and FIG. 19C is after 80th cycle.

FIG. 20 is a graph of the direct current (DC) polarization curve of the cell according to Comparative Example 2.

FIG. 21 is a graph of the DC polarization curve of a cell according to Example 7.

FIG. 22 is a graph showing the cycle characteristics (1.0C) of cells according to Comparative Example 7 and Examples 12-14.

FIG. 23 is a graph showing the cycle characteristics (1.0C) of cells according to Comparative Example 8 and Example 15.

FIG. 24 is a graph showing the cycle characteristics (1.0C) of cells according to Comparative Examples 4-6 and Examples 9-11.

FIG. 25 is a graph showing the cycle characteristics of cells according to Comparative Example 4, Comparative Example 10, and Example 9.

FIG. 26 is an exemplary drawing of the lithium metal battery.

The drawings described herein are for illustration purposes only and are not intended to limit the scope of the present disclosure in any way.

### DETAILED DESCRIPTION

In the present specification, terms including first, second, and third are used for describing various arts, components, regions, layers, and/or sections, but are not limited thereto. The terms are only used to distinguish any part, component, region, layer, or section from the other part, component, region, layer, or section. Accordingly, the first part, component, region, layer, or section described below may be mentioned as the second part, component, region, layer, or section within the range without departing from the range of the present disclosure.

Special terms used herein is for the purpose of describing specific embodiments only and are not intended to be limiting of the present disclosure. The singular forms used herein include plural forms as well, if the phrases do not clearly have the opposite meaning. The term “including” or “comprising” used in the specification means that a specific feature, region, integer, step, operation, element and/or component is embodied and other specific features, regions, integers, steps, operations, elements, and/or components are not excluded.

When any part of or referred to as being “on”, “over” the other part, which might be directly on or over the other parts or may be a different part involves therebetween. On the contrary, when any part is mentioned as being “directly on” the other parts, the other part is not interposed therebetween.

Unless defined otherwise, all terms including technical and scientific terms used herein have the same meaning as commonly understood by those having ordinary skill in the art to which the present disclosure belongs. Commonly used predefined terms are further interpreted as having a meaning consistent with the relevant technical literature and the present disclosure, and are not to be construed as ideal or very formal meanings unless defined otherwise.

As used herein, the term “combination(s) thereof” described in the expression in the Markush format refers to one or more mixtures or combinations selected from the components described in the expression in the Markush format, and refers to including at least one selected from the components. In the present disclosure, each of phrases such as “A or B”, “at least one of A and B”, “at least one of A or B”, “A, B or C”, “at least one of A, B and C”, “at least one of A, B or C”, “at least one of A, B, or C, or a combination thereof” and “at least one of A, B, or C, or any combination thereof” may include any one or all possible combinations of the items listed together in the corresponding one of the phrases.

Additionally, as used herein, when specific definition is not otherwise provided, “*” means a portion linked to the same or different atoms or chemical formulas.

Hereinafter, the present disclosure will be described more fully, in which embodiments of the present disclosure are shown. As those having ordinary skill in the art would realize, the described embodiments may be modified in various different ways, all without departing from the spirit or scope of the present disclosure.

An embodiment of the present disclosure provides a lithium metal battery including a lithium metal negative electrode integrated with a polymer support film storing an additive lithium salt capable of improving the performance of the lithium metal battery.

The polymer support film including the additive lithium salt according to an embodiment of the present disclosure is manufactured by coating a solution including the additive lithium salt and the polymer on the surface of lithium metal through a solution casting method and then drying it. The manufactured polymer support film is chemically and electrochemically stable with lithium metal, has a very thin thickness and low ionic conductivity resistance, and has a porous structure, which facilitates impregnation of electrolyte and elution of additive lithium salt.

The polymer support film according to an embodiment of the present disclosure may support an additive lithium salt for a lithium metal battery in an amount exceeding the solubility limit of the electrolyte and include it inside the lithium metal battery. The polymer support film may improve cycle-life characteristics of a lithium metal battery by enabling the function of an additive salt that is difficult to utilize due to its very low solubility in the electrolyte, or by additionally providing an additive lithium salt that is depleted during the operation of the lithium metal battery.

In addition, the polymer support film is applicable to a specific electrolyte and additive lithium salt composition, and may also be applied to all electrolytes and additive lithium salt compositions in which the additive lithium salt above the solubility limit may have a positive effect in a lithium metal battery.

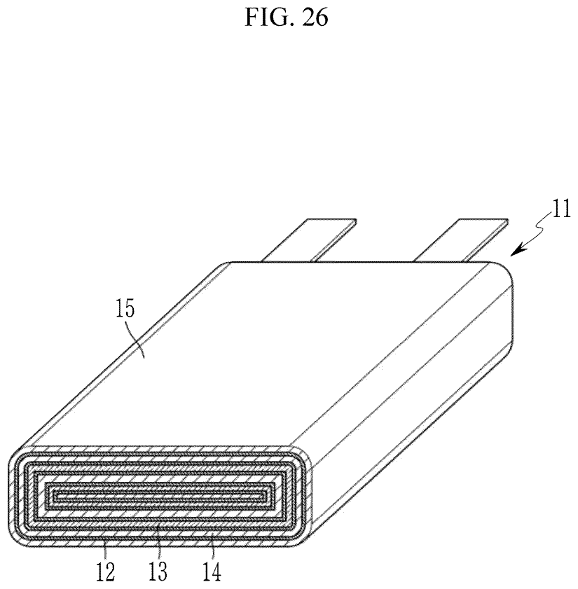

A lithium metal battery (11) according to an embodiment includes a positive electrode (13); a lithium metal negative electrode (!2) opposite to the positive electrode; and a separator (14) between the positive electrode and the negative electrode. The lithium metal negative electrode is integrated with a porous polymer support film that supports an additive lithium salt. (referring FIG. 26)

These lithium metal batteries may be applied to various fields such as energy storage devices such as portable devices, electric vehicles, and medium and large-scale energy storage systems (ESS), and the concept also includes various rechargeable batteries such as lithium sulfur batteries and non-negative electrode batteries.

The term “integrated” may mean that there is no separation between the porous polymer support film and the lithium metal layer coated with the porous polymer support film. Through this integration, the aforementioned effects can be dramatically realized.

Specifically, the lithium metal negative electrode integrated with the porous polymer support film that supports the additive lithium salt may include current collector; a lithium metal layer on the current collector; and a porous polymer support film that supports the additive lithium salt and is coated on the surface of the lithium metal layer. The lithium metal layer and the porous polymer support film may be integrated and not be physically separated from each other (after manufacturing).

In an embodiment of the present disclosure, a polymer support film including an additive lithium salt for improving the performance of a lithium metal battery is manufactured in a form integrated with lithium metal. The polymer support film manufactured in this way has a porous structure that is advantageous for electrolyte impregnation ability and elution of the supported additive lithium salt. In addition, the polymer support film may be manufactured with a thin thickness of 5 μm or less, for example, 3 μm to 5 μm, so that the increase in resistance within the battery is very small and the decrease in energy density per volume may be minimized. As the supported additive lithium salt, various salts known to be capable of improving the performance of lithium metal batteries may be applied, and the supported salt may continuously be eluted in extremely small amounts even in solvents with very low solubility and act electrochemically, thereby improving cycle-life characteristics of lithium-metal batteries.

For example, the additive lithium salt may include at least of LiNO₃, LiDFOB, LiBOB(Lithium bis(oxalato)borate), LiPO₂F₂, LiPF₆, LiBF₄, LiN(SO₂F)₂, LiN(SO₂C₂F₅)₂, LiCF₃SO₃, LiC₄F₉O₃, LiC₆H₅SO₃, LiSCN, LiB(C₂O₄)₂, LiDFOP(Lithium difluoro(bisoxalato)phosphate), or any combination thereof.

Specifically, the additive lithium salt may include a first additive lithium salt and a second additive lithium salt, the first additive lithium salt may include LiNO₃, and the second additive lithium salt includes at least one of LiDFOB, LiBOB, LiPO₂F₂, LiPF₆, LiBF₄, LiN(SO₂F)₂, LiN(SO₂C₂F₅)₂, LiCF₃SO₃, LiC₄F₉O₃, LiC₆H₅SO₃, LiSCN, LiB(C₂O₄)₂, LiDFOP, or any combination thereof. The first additive lithium salt may be included in a greater amount than the second additive lithium salt. For example, lithium nitrate (a first additive lithium salt) which is known to form an excellent film on the surface of a lithium metal, and lithium difluoro(oxalate) borate (a first additive lithium salt) which is also known to form an excellent film and help stable charge/discharge in a high-voltage driving positive electrode may be used as the additive lithium salt.

At this time, the first additive lithium salt and the second additive lithium salt may be included in a weight ratio of 3:1 to 5:1, for example, a weight ratio of 4:1.

Meanwhile, the additive lithium salt may be included in an amount of 2 wt % to 20 wt %, for example, 2 wt % to 15 wt %, for example, 2 wt % to 10 wt %, for example, 2.5 wt % to 10 wt %, based on the total amount (100 wt %) of the porous polymer support film.

When the additive lithium salt is controlled to the above composition, it may be very easy to integrate the manufactured porous polymer support film into the lithium metal layer with a thin thickness.

The porous polymer support film may further include a polymer, wherein the polymer may include at least one of poly(vinylidene fluoride-hexafluoropropylene) copolymer (PVdF-HFP), polyvinylidene fluoride (PVdF), polytetrafluoroethylene (PTFE), polymethyl methacrylate (PMMA), polyethylene oxide (PEO), polypropylene (PP), polyimide (PI), polyamideimide (PAI), polystyrene (PS), polyvinyl chloride (PVC), polyetheretherketone (PEEK), polyestersulfone (PES), or any combination thereof.

For example, the composition of the porous polymer support film may use a poly(vinylidene fluoride-co-hexafluoropropylene) copolymer (PVdF-HFP, trade name: Kynar) polymer that has excellent electrochemical stability, so that no decomposition reaction occurs when a lithium metal battery is operated, and has good compatibility with various electrolytes used in rechargeable lithium batteries. By mixing the polymer and the additive lithium salt and directly coating it on the surface of lithium metal using a solution casting method, a polymer support film having a porous structure in which the additive lithium salt is supported in an integrated form with the lithium metal may be very easily manufactured.

The lithium metal integrated with the porous polymer support film may be applied to electrolytes of a specific composition, and also to electrolytes of various compositions in which an excess of additive lithium salt has a positive effect on cycle-life characteristics.

For example, the electrolyte may be prepared by mixing a lithium salt and a non-aqueous organic solvent, and the non-aqueous organic solvent may be prepared by mixing at least one of a carbonate-based organic solvent, an ether-based organic solvent, a sulfonamide solvent, a fluorine-based organic solvent, or any combination thereof.

The lithium salt used in the electrolyte may include at least one of LiN(SO₂F)₂, LiN(SO₂C₂F₅)₂, LiN(CF₃SO₂)₂, LiPF₆, LiBF₄, LiClO₄, LiCF₃SO₃, LiC₄F₉O₃, LiC₆H₅SO₃, LiSCN, LiB(C₂O₄)₂, and LiDFOP.

The ether-based organic solvent used in the electrolyte may include at least one of 1,2-dimethoxyethane, 1,3-dioxalane, tetrahydrofuran, or any combination thereof. The carbonate-based organic solvent may include at least one of ethylene carbonate, propylene carbonate, dimethyl carbonate, diethyl carbonate, ethylmethyl carbonate, fluoroethylene carbonate, difluoroethylene carbonate, fluorodimethyl carbonate, fluoroethylmethyl carbonate, or any combination thereof. The sulfonamide solvent may include at least one of N,N-dimethyl fluorosulfonamide, N-N-dimethyl trifluoromethane sulfonamide, N-butyl-N,N,N-trimethylsulfonamide, N-butyl-N-methyl-trifluoromethanesulfonamide, or any combination thereof. The fluorine-based organic solvent may include at least one of 1,1,2,2-tetrafluoroethyl-1H,1H,5H-octafluoropentyl ether (TFOFE), 1,1,2,2-tetrafluoroethyl-2,2,2,3-tetrafluoropropyl ether (TTE), bis(2,2,2-trifluoroethyl) ether (BTFE), 1,1,2,2-tetrafluoroethyl-2,2,2-trifluoroethyl ether (TFTFE), methoxynonafluorobutane (MOFB), ethoxynonafluorobutane (EOFB), or any combination thereof.

For example, the porous polymer support film may have a thickness of 5 μm or less, for example, 3 μm to 5 μm.

The lithium metal negative electrode includes a current collector such as copper, a lithium metal layer, and a porous polymer support film. The thickness of the porous polymer support film should be controlled within the above range, so that it is easy to control the thickness of the lithium metal layer to be thicker than the current collector, and at the same time, it is easy to control the thickness of the current collector to be thicker than the porous polymer support film. By controlling the thickness of each layer constituting the lithium metal negative electrode in this way, the thickness of the lithium metal negative electrode finally manufactured may be easily controlled to 5 μm to 200 μm, for example, 10 μm to 100 μm, for example, 10 μm to 50 μm, for example, 10 μm to 30 μm. Such thickness control may significantly improve cycle characteristics of a lithium metal battery including the lithium metal negative electrode.

The positive electrode in the lithium metal battery includes a positive electrode active material, and the positive electrode active material is a compound capable of reversible intercalation and deintercalation of lithium, and specifically may include lithium iron phosphate.

The positive electrode active material is a compound capable of reversible intercalation and deintercalation of lithium, and specifically may include a lithium metal oxide including at least one of cobalt, manganese, nickel, phosphorus, iron, sulfur, aluminum, or any combination thereof. More specifically, the lithium metal oxide may include at least one of lithium-manganese-based oxide, lithium-cobalt-based oxide, lithium-nickel-based oxide, lithium-iron phosphate-based oxide, lithium-nickel-manganese-based oxide, lithium-nickel-cobalt-based oxide, lithium-manganese-cobalt-based oxide, lithium-nickel-manganese-cobalt-based oxide, lithium-nickel-manganese-cobalt-based oxide, lithium-nickel-manganese-aluminum oxide, lithium-nickel-cobalt-transition metal (M) oxide, or any combination thereof.

For example, the positive electrode active material may include at least one of LiCoO₂, LiNiₓCo_{y}Mn_{z}O₂ (x, y, and z are each independently real numbers from 0 to 1, where x+y+z=1), LiNiₓCo_{y}Al_{z}O₂ (x, y, and z are each independently real numbers from 0 to 1, where x+y+z=1), LiFePO₄, sulfur, or any combination thereof.

In particular, a lithium metal battery according to an embodiment may have excellent compatibility with a high nickel (high Ni) positive electrode active material that can improve the capacity characteristics and stability of the battery, and thus the positive electrode active material may include LiNiₓCo_{y}Mn_{z}O₂ (x, y, and z are each independently real numbers from 0 to 0.8≤x<1, x+y+z=1), LiNiₓCo_{y}Al_{z}O₂ (x, y, and z are each independently real numbers from 0 to 1, 0.8≤x<1, x+y+z=1), or a combination thereof.

Specifically, the positive electrode may include a positive electrode current collector and a positive electrode active material layer formed on the positive electrode current collector.

The positive electrode current collector may be made of stainless steel, aluminum, nickel, titanium, calcined carbon, or aluminum or stainless steel surface-treated with carbon, nickel, titanium, silver, and the like.

The thickness of the positive electrode current collector may be 3 μm to 500 μm.

The positive electrode active material layer may further include a binder and/or a conductive material.

The separator separates the negative electrode and the positive electrode and provides a passage for lithium ions to move, and is not particularly limited as long as it is a separator commonly used in rechargeable lithium batteries.

According to another embodiment, a method for producing lithium metal integrated with a porous polymer support film that supports an additive lithium salt is provided. The method includes: mixing an organic solvent, a polymer, and an additive lithium salt to obtain a polymer solution; coating the polymer solution on a lithium metal surface; and drying the polymer solution coated on the lithium metal surface.

The additive lithium salt or polymer may be the same as described above.

The polymer solution may be coated on the lithium metal surface to a thickness of 30 μm to 80 μm. By coating the polymer solution to the thickness, the thickness of the porous polymer support film finally manufactured after drying may be easily controlled to 5 μm or less, for example, 3 μm to 5 μm.

For example, the mixing of the organic solvent, polymer, and additive lithium salt may be performed at 30 °C to 50 °C.

For example, the drying may be performed at a temperature of 80 °C to 100 °C under vacuum conditions for 6 to 24 hours.

By controlling the process conditions as described above, it may be possible to manufacture a lithium metal negative electrode of better quality.

The following examples illustrate embodiments of the present disclosure in more detail. However, the following examples are only examples of the present disclosure, and the present disclosure is not limited to the following examples.

### EXAMPLES

### Preparation of Electrolyte

### Example 1: Sulfonamide-Based Electrolyte

A sulfonamide-based liquid electrolyte was prepared by mixing dimethyl fluorosulfoneamide (DNSF) as a sulfone amide-based solvent and lithium bis(fluoro sulfonylimide) (LiFSI) in a molar ratio of 3:1.

### Example 2: Carbonate-Based Electrolyte for Lithium Metal Battery

A carbonate-based electrolyte for a lithium metal battery was prepared by dissolving 0.8 M of lithium bis(trifluoromethane sulfonyl)imide (LiTFSI), 0.2 M of lithium difluoro(oxalate)borate (LiDFOB), and 0.05 M of lithium hexafluorophosphate (LiPF₆) in an organic solvent prepared by mixing fluoroethylene carbonate (FEC) of a carbonate-based cyclic solvent and ethylmethyl carbonate (EMC) of a linear solvent in a volume ratio of 25/75.

### Example 3: Carbonate-Based Electrolyte for Lithium Metal Battery

A carbonate-based electrolyte for a lithium metal battery was prepared by dissolving 1.15 M of lithium hexafluorophosphate (LiPF₆) in a mixed organic solvent of ethylene carbonate (EC), ethylmethylcarbonate (EMC), diethylcarbonate (DEC) in a volume ratio of 3/5/2 and then, adding 5 wt % of fluoroethylene carbonate (FEC) thereto.

### Manufacturing of Lithium Metal Negative Electrode

### Example 4: Lithium Negative Electrode Integrated with Polymer Support Film Including Lithium Nitrate

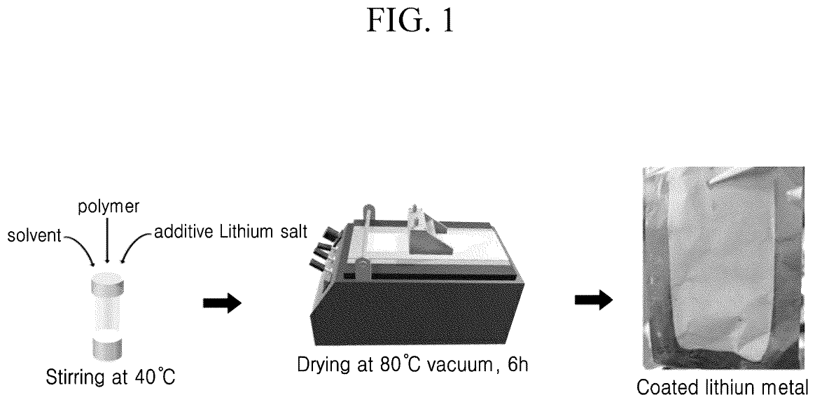

A polymer solution was prepared by adding PVdF-HFP polymer and lithium nitrate in each amount of 10 wt % to a dimethyl acetamide organic solvent and then, stirring them at 45 °C for 24 hours. The prepared solution was coated to be 50 μm thick on the surface of a lithium metal by using a doctor blade and then, dried it at 90 °C under vacuum for 24 hours to manufacture a porous polymer support film containing the lithium nitrate and having a thickness of less than or equal to 5 μm. FIG. 1 shows the process of manufacturing the lithium negative electrode integrated with the polymer support film containing the lithium nitrate.

### Example 5: Lithium Negative Electrode Integrated with Polymer Support Film Including Lithium Difluoro(Oxalate)Borate

A polymer solution was prepared by adding a PVdF-HFP polymer and a lithium difluoro(oxalate) borate salt in each amount of 10 wt % in a dimethyl acetamide organic solvent and then, stirring them at 45 °C for 24 hours. Subsequently, a porous polymer fiber protective layer containing the lithium difluoro(oxalate) borate salt and having a thickness of less than or equal to 5 μm was manufactured in the same manner as in Example 4.

### Example 6: Lithium Negative Electrode Integrated with Polymer Support Film Including Lithium Nitrate and Lithium Difluoro(Oxalate)Borate Together

A PVdF-HFP polymer, a lithium nitric acid salt, and a lithium difluoro(oxalate) borate salt were added in each amount of 10 wt %, 10 wt %, and 2.5 wt % to a dimethyl acetamide organic solvent and then, stirred at 45 °C for 24 hours to prepare a polymer solution. Subsequently, a porous polymer fiber protective layer containing the lithium nitrate salt and the lithium difluoro(oxalate) borate salt and having a thickness of less than or equal to 5 μm was manufactured in the same manner as in Example 4.

### Comparative Example 1: Lithium Negative Electrode Integrated with PVDF-HFP Polymer Film

10 wt % of a PVdF-HFP polymer was added to a dimethyl acetamide organic solvent and then, stirred at 45 °C for 24 hours to prepare a polymer solution. The prepared solution was coated on the lithium metal surface to have a thickness of less than or equal to 5 μm by using a doctor blade and then, dried at 90 °C under vacuum for 24 hours to manufacture a lithium negative electrode integrated the polymer film having a thickness of less than or equal to 5 μm.

Manufacturing of a Porous Polymer Separator Separated from Lithium Negative Electrode

### Comparative Example 9: Polymer Film Including Additive Lithium Salt not Integrated with Lithium Metal

A PVdF-HFP polymer and lithium nitrate were added in each amount of 10 wt % to a dimethyl acetamide organic solvent and then, stirred at 45 °C for 24 hours to prepare a polymer solution. The prepared solution was coated to be 50 μm thick on a polyethylene terephthalate (PET)-based release film by using a doctor blade and then, dried at 90 °C under vacuum for 24 hours to manufacture a porous polymer support film having a thickness of 5 μm or so, which was separated.

### Manufacturing of Battery Cell

### Example 7: Coin-Type Lithium Symmetric Battery Using Lithium Negative Electrode Including Sulfonamide-Based Electrolyte and Lithium Nitrate Support Film

The electrolyte according to Example 1 and the lithium electrode integrated with the support film according to Example 4 were used to manufacture a coin-type lithium symmetric battery cell (lithium/electrolyte/lithium). Herein, a polyethylene separator was used to separate two electrodes.

### Example 8: Coin-Type Lithium/Stainless Steel (SUS) Battery Using Lithium Negative Electrode Including Sulfonamide-Based Electrolyte and Lithium Nitrate Support Film

In order to analyze electrochemical characteristics of the manufactured lithium nitrate-containing polymer fiber film, a lithium negative electrode and a stainless steel (SUS) electrode were used to manufacturing a coin-type battery cell. Herein, Example 1 was used as an electrolyte, and Example 4 was used as the lithium metal negative electrode. The lithium metal was used as a reference and counter electrode, and the SUS electrode was used as a work electrode. A polyethylene separator was used to separate two electrodes.

### Examples 9-15: Coin-Type Lithium Metal Batteries Using Various Electrolytes and Support Films (See Table 1)

A lithium metal negative electrode and an electrolyte provided in Table 1 were used to manufacture a coin-type lithium-metal battery cell. As a positive electrode, a high nickel positive electrode active material of LiNi_{0.8}Co_{0.1}Mn_{0.1}O₂ was used. Herein, the lithium metal used as a negative electrode had a thickness of 20 μm (a copper (Cu) current collector had a thickness of 10 μm), and the positive electrode had capacity per area of 4.0 mAh/cm². The electrolyte was 6 g/Ah, and a polyethylene separator was used to separate the negative electrode and the positive electrode.

TABLE 1

| | Electrolyte | Lithium metal negative electrode |
|---|---|---|
| Example 9 | Example 1 | Example 4 |
| Example 10 | Example 1 | Example 5 |
| Example 11 | Example 1 | Example 6 |
| Example 12 | Example 2 | Example 4 |
| Example 13 | Example 2 | Example 5 |
| Example 14 | Example 2 | Example 6 |
| Example 15 | Example 3 | Example 4 |

### Comparative Example 2: Coin-Type Lithium Symmetric Battery Using Sulfonamide-Based Electrolyte

The electrolyte of Example 1 was used to manufacture a coin-type lithium symmetric battery cell (lithium/electrolyte/lithium). Herein, a polyethylene separator was used to separate two electrodes.

### Comparative Example 3: Coin-Type Lithium/SUS Battery Using Sulfonamide-Based Electrolyte

A lithium negative electrode and a stainless steel (SUS) electrode were used to manufacture a coin-type battery cell. Example 1 was used as an electrolyte, and Comparative Example 1 was used as the lithium metal negative electrode. The lithium metal was used as a reference and counter electrode, and the SUS electrode was used as a work electrode. A polyethylene separator was used to separate two electrodes.

### Comparative Example 4: Coin-Type Lithium Metal Battery Using Sulfonamide-Based Electrolyte

A lithium metal negative electrode and the electrolyte of Example 1 were used to manufacture a coin-type lithium metal battery cell. As a positive electrode, a high nickel positive electrode active material of LiNi_{0.8}Co_{0.1}Mn_{0.1}O₂ was used. Herein, the lithium metal used as a negative electrode had a thickness of 20 μm (a Cu current collector had a thickness of 10 μm), and the positive electrode has capacity per area of 4.0 mAh/cm². The electrolyte was 6 g/Ah, and a polyethylene separator was used to separate the negative electrode and the positive electrode.

### Comparative Example 5: Coin-Type Lithium Metal Battery Using Sulfonamide-Based Electrolyte Including Polymer Film not Supporting Additive Lithium Salt

The lithium metal negative electrode of Comparative Example 1 and the electrolyte of Example 1 were used to manufacture a coin-type lithium metal battery cell. As a positive electrode, a high nickel positive electrode active material of LiNi_{0.8}Co_{0.1}Mn_{0.1}O₂ was used. Herein, the lithium metal used as a negative electrode had a thickness of 20 μm (a Cu current collector had a thickness of 10 μm), and the positive electrode had capacity per area of 4.0 mAh/cm². The electrolyte was 6 g/Ah, and a polyethylene separator was used to separate the negative electrode and the positive electrode.

### Comparative Example 6: Coin-Type Lithium Metal Battery Using a Sulfonamide-Based Electrolyte Including Lithium Nitrate

A lithium metal negative electrode and an electrolyte prepared by adding 0.05 wt % of lithium nitrate to the electrolyte of Example 1 were used to manufacture a coin-type lithium metal battery cell. As a positive electrode, a high nickel positive electrode active material of LiNi_{0.8}Co_{0.1}Mn_{0.1}O₂ was used. Herein, the lithium metal used as a negative electrode had a thickness of 20 μm (a Cu current collector had a thickness of 10 μm), and the positive electrode had capacity per area of 4.0 mAh/cm². The electrolyte was 6 g/Ah, and a polyethylene separator was used to separate the negative electrode and the positive electrode.

### Comparative Example 7: Coin-Type Lithium Metal Battery Using Carbonate-Based Electrolyte for Lithium Metal Batteries

A lithium metal negative electrode and the electrolyte of Example 2 were used to manufacture a coin-type lithium metal battery cell. As a positive electrode, a high nickel positive electrode active material of LiNi_{0.8}Co_{0.1}Mn_{0.1}O₂ was used. Herein, the lithium metal used as a negative electrode had a thickness of 20 μm (a Cu current collector had a thickness of 10 μm), and the positive electrode had capacity per area of 4.0 mAh/cm². The electrolyte was 6 g/Ah, and a polyethylene separator was used to separate the negative electrode and the positive electrode.

### Comparative Example 8: Coin-Type Lithium Metal Battery Using Carbonate-Based Electrolyte for Lithium Ion Battery

A lithium metal negative electrode and the electrolyte of Example 3 were used to manufacture a coin-type lithium metal battery cell. As a positive electrode, a high nickel positive electrode active material of LiNi_{0.8}Co_{0.1}Mn_{0.1}O₂ was used. Herein, the lithium metal used as a negative electrode had a thickness of 20 μm (a Cu current collector had a thickness of 10 μm), and the positive electrode had capacity per area of 4.0 mAh/cm². The electrolyte was 6 g/Ah, and a polyethylene separator was used to separate the negative electrode and the positive electrode.

### Comparative Example 10: Coin-Type Lithium Metal Battery Using a Sulfonamide-Based Electrolyte Including Additive Support Film that is not Integrated with Lithium Metal

The independent (separated) support film of Comparative Example 9 was placed to face a lithium metal and then, used with the electrolyte of Example 1 to manufacture a coin-type lithium metal battery cell. As a positive electrode, a high nickel positive electrode active material of LiNi_{0.8}Co_{0.1}Mn_{0.1}O₂ was used. Herein, the lithium metal used as a negative electrode had a thickness of 20 μm (a Cu current collector had a thickness of 10 μm), and the positive electrode had capacity per area of 4.0 mAh/cm². The electrolyte was 6 g/Ah, and a polyethylene separator was used to separate the negative electrode and the positive electrode.

### EXPERIMENTAL EXAMPLE

### 1. Microstructural Analysis of Polymer Films Supporting Additive Lithium Salt

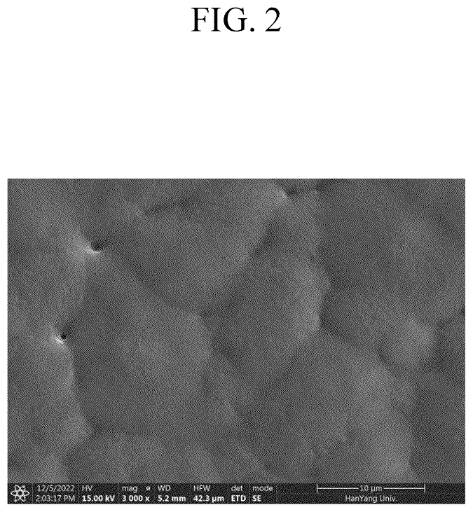

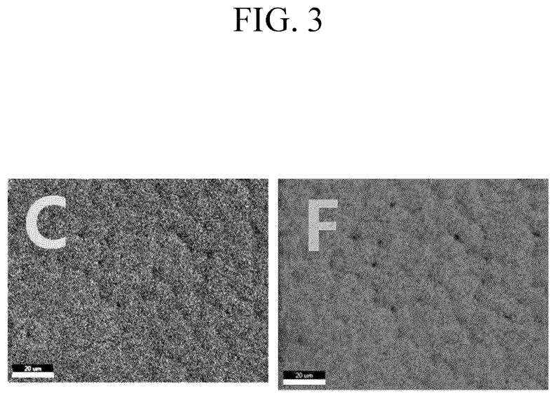

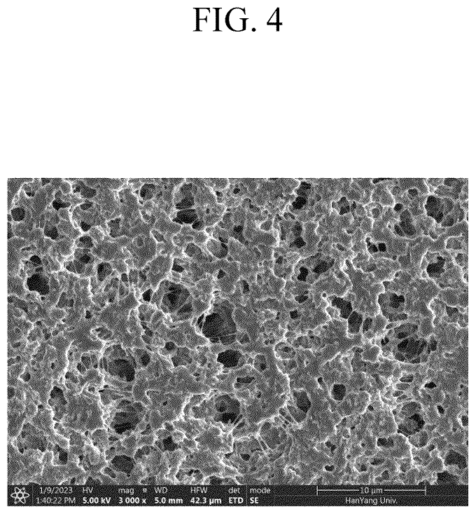

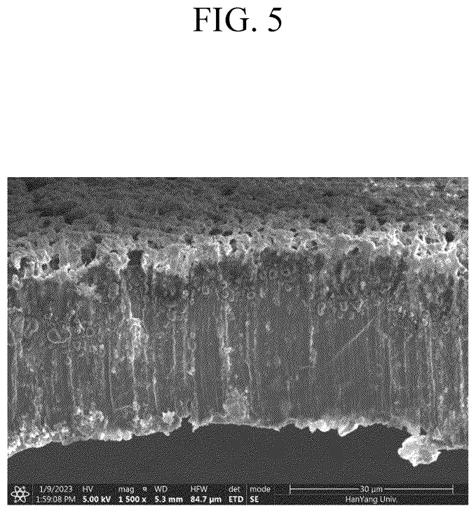

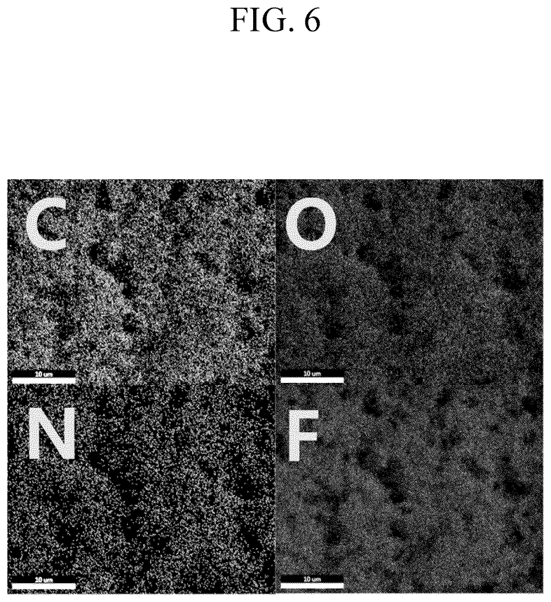

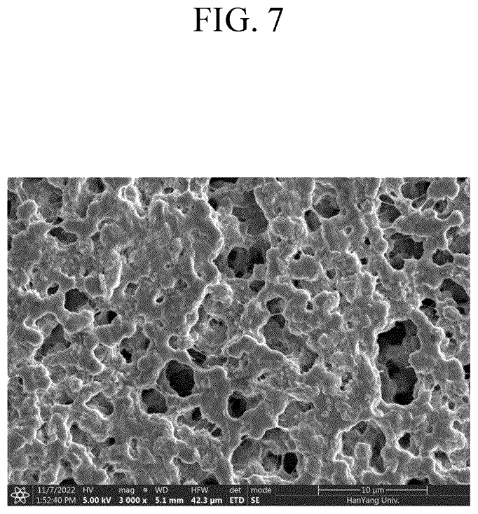

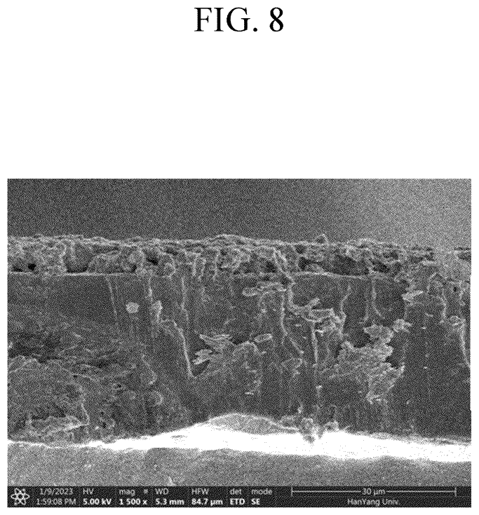

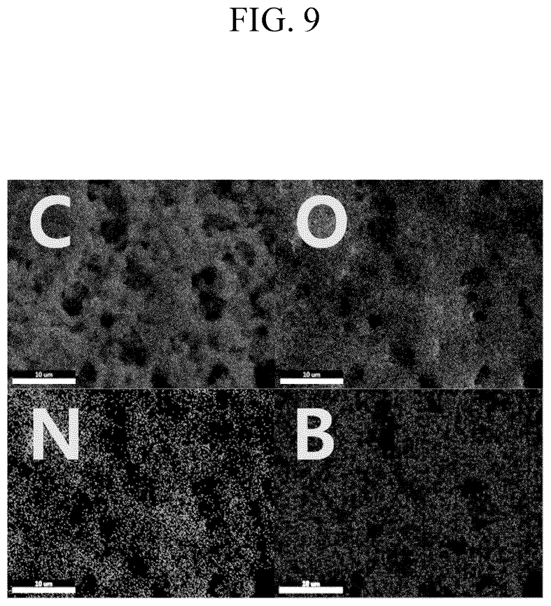

The microstructural images of the manufactured polymer films analyzed through scanning electron microscope (SEM) and energy dispersive X-ray spectroscopy (EDX) are shown in FIGS. 2-9. The analysis results show that when supported with an additive lithium salt as in Examples 4 and 6, a porous structure was observed, but when not supported with the additive lithium salt, a dense structure was observed. The EDX analysis results confirmed that N and B elements representing the additive lithium salt and C and F elements representing the PVDF-HFP polymer were uniformly present. The cross-section analysis results confirmed that the polymer film supported with the additive lithium salt had a porous structure and a thickness of less than or equal to 5 μm.

### 2. Confirmation of the Electrochemical Behavior of Polymer Film Supporting Lithium Nitrate

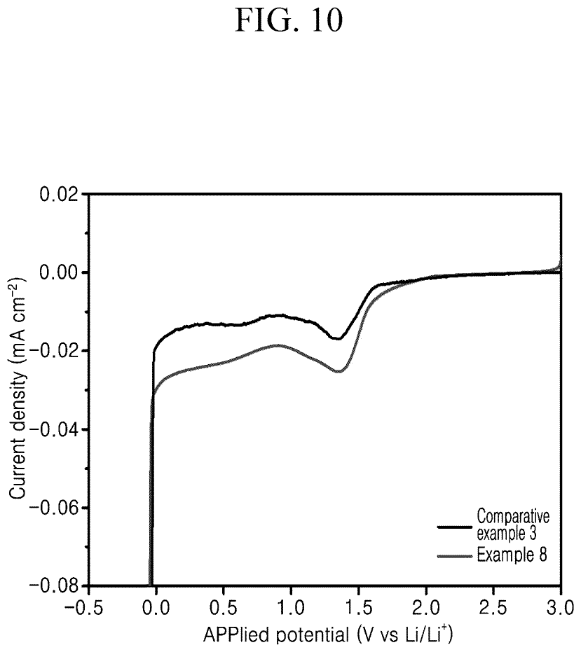

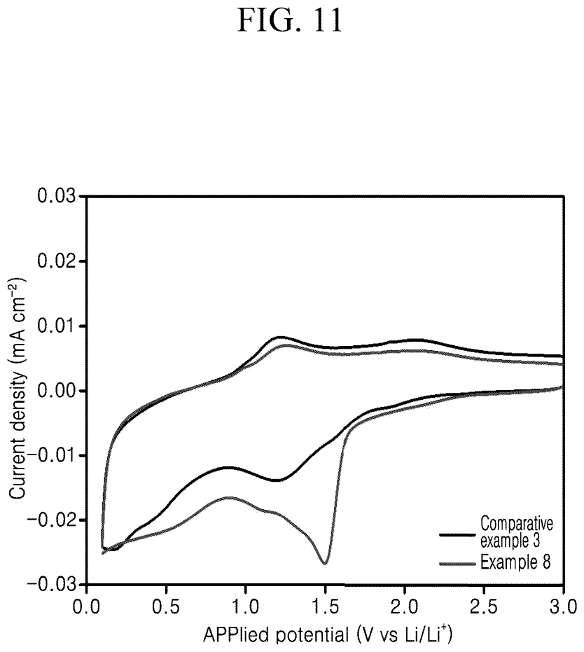

The polymer support film supported with lithium nitrate (Example 4) was checked with respect to an electrochemical behaviors by using the lithium metals manufactured through Comparative Example 3 and Example 8 and an SUS electrode to manufacture each battery cell, which was subjected to a linear scanning current method at room temperature at 1 mV/s, and the results are shown in FIG. 10. In addition, the cyclic voltammetry results of battery cells with the same configuration as above at 0.1 mV/s and room temperature are shown in FIG. 11. Referring to FIGS. 10 and 11, when the polymer support film containing lithium nitrate was applied, a current was generated from about 1.7 V, which is known as a reduction potential of the lithium nitrate, confirming that the lithium nitrate supported on the polymer film electrochemically acted.

3. Confirmation of Electrochemical Resistance Changes when Applying a Film Including Lithium Nitrate

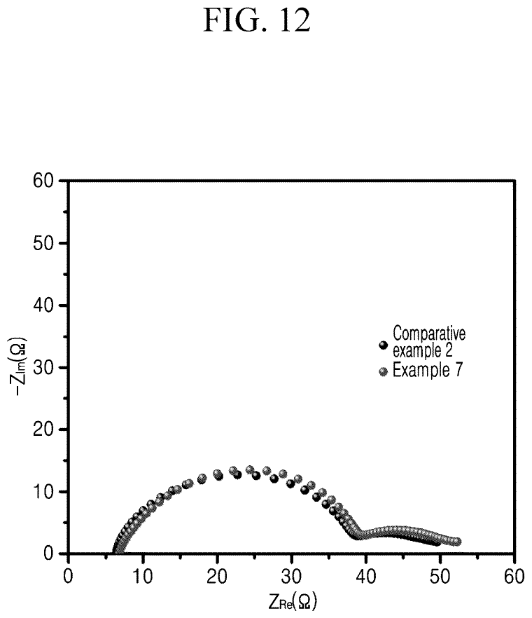

In order to check changes in internal resistance of battery cells when the polymer support film supported with lithium nitrate (Example 4) was applied, the lithium|electrolytellithium battery cells of Comparative Example 2 and Example 7 were measured with respect to internal resistance at room temperature by using an alternating current (AC) impedance analyzer, and the results are shown in FIG. 12. The AC impedance was measured by applying a voltage of 5 mV within a range of 1,000,000 Hz to 1 Hz. The measurement results confirmed that Example 7, compared to Comparative Example 2, exhibited the battery internal resistance slightly increased but remained at almost the same level, which confirmed that the polymer support film with a porous structure did not interfere with ion conduction within the battery cell.

4. Confirmation of Changes in Lithium Electrodeposition Morphology in Sulfonamide-Based Electrolyte when Applying Polymer Support Film Including Lithium Nitrate.

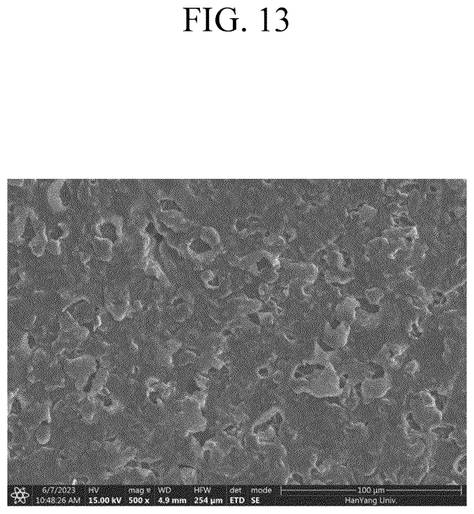

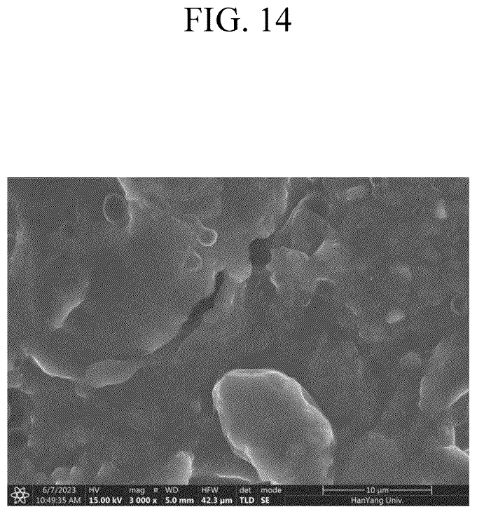

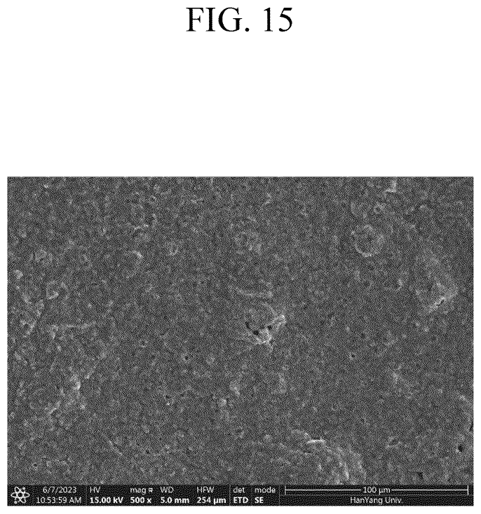

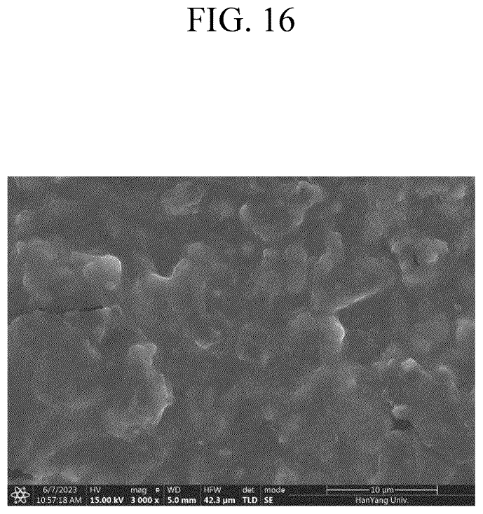

The lithium metal battery cells manufactured through Comparative Example 4 and Example 9 were once charged at a rate of 0.1 C and then, disassembled in the charged state to take the lithium metal negative electrodes, which were analyzed with respect to their microstructures through SEM, and the results are shown in FIGS. 13-16. The image analysis results confirmed that lithium electrodeposited in Example 9 had denser and more uniform morphology than that deposited in Comparative Example 4. Through this, it was confirmed that when a polymer support film supported with lithium nitrate was applied in a sulfonamide-based electrolyte, the electrodeposited lithium exhibited more uniform morphology.

5. Analysis of Lithium Negative Electrode Film Components when Applying a Polymer Support Film Including Lithium Nitrate

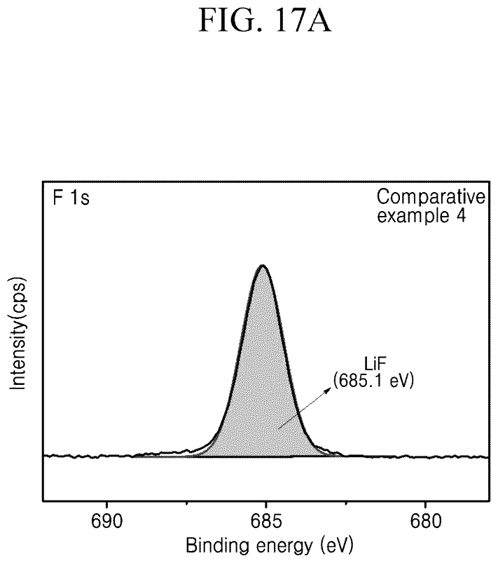

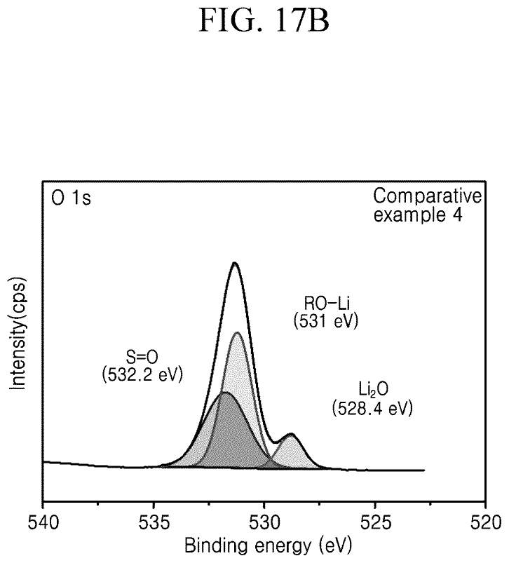

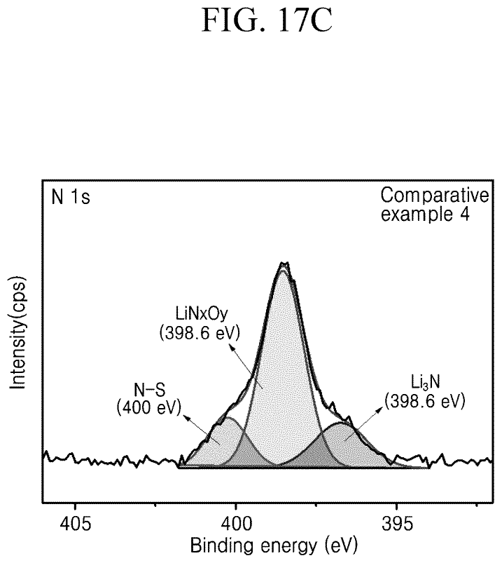

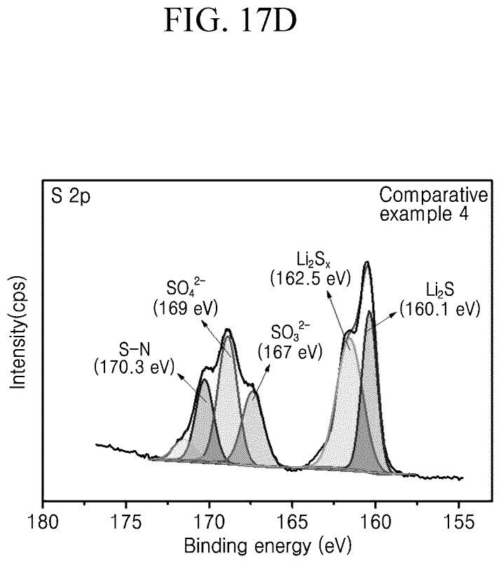

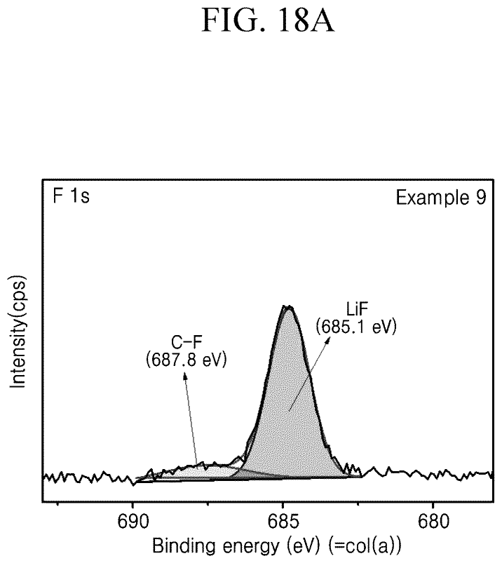

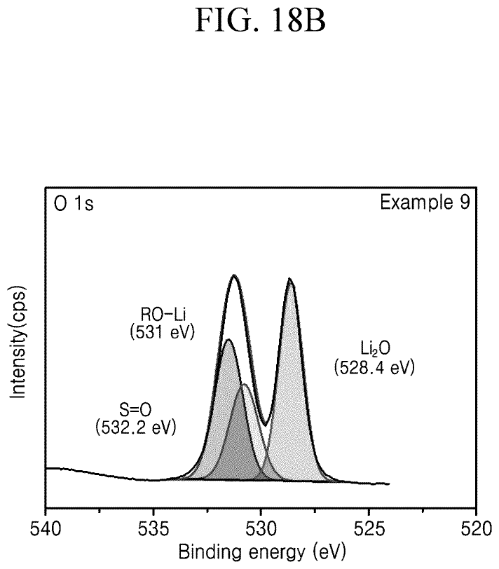

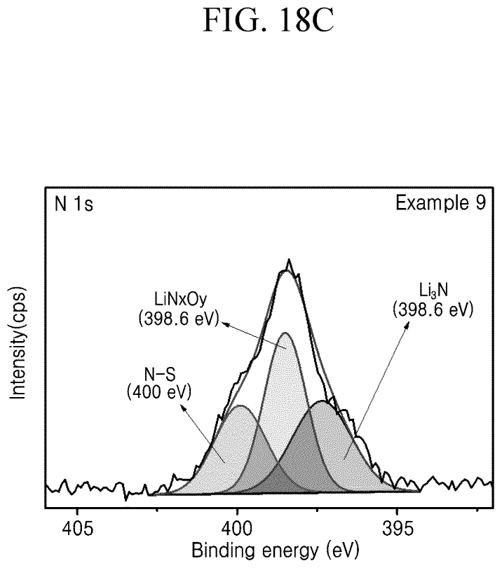

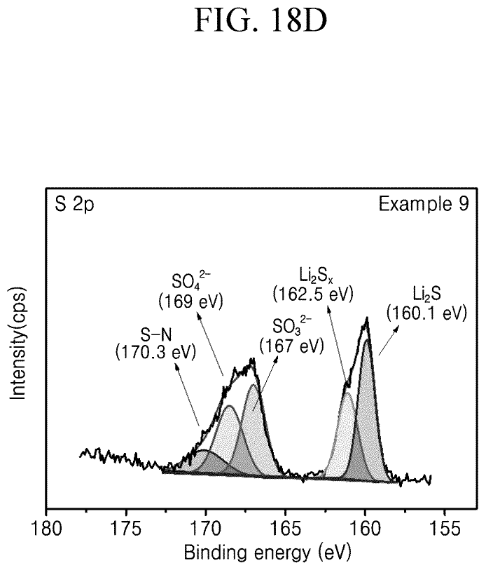

Table 2, FIGS. 17A-17D, and FIG. 18A-18D show the results after 5 cycles driving the lithium metal battery cells of Comparative Example 4 and Example 9 at 1.0 C, when the lithium metal negative electrodes obtained therefrom in the charged state were subjected to X-ray photoelectron spectroscopy analysis on the surface. When the polymer support film containing lithium nitrate was included, it was confirmed that an amount ratio of Li₂O, Li₃N, and the like significantly increased due to the formation of the lithium nitrate film. As a result of elemental fraction analysis, Example 9 exhibited a significant decrease in a C content, through which the film formation was suppressed by decomposition of the sulfoneamide electrolyte solvent in Example 9. The increased fractions of elements such as N, F, S, and the like in Comparative Example 4 were due to decomposition of the sulfonamide electrolyte solvent.

TABLE 2

| | Li 1 s | C 1 s | N 1 s | O 1 s | F 1 s | S 2 p |
|---|---|---|---|---|---|---|
| Comparative | 36.9% | 24.8% | 1.6% | 27.4% | 5.4% | 3.9% |
| Example 4 | | | | | | |
| Example 9 | 53.5% | 9.6% | 0.9% | 34.0% | 1.0% | 1.0% |

### 6. Confirmation of Lithium Nitrate Consumption in Polymer Films Through Ion Chromatography Analysis.

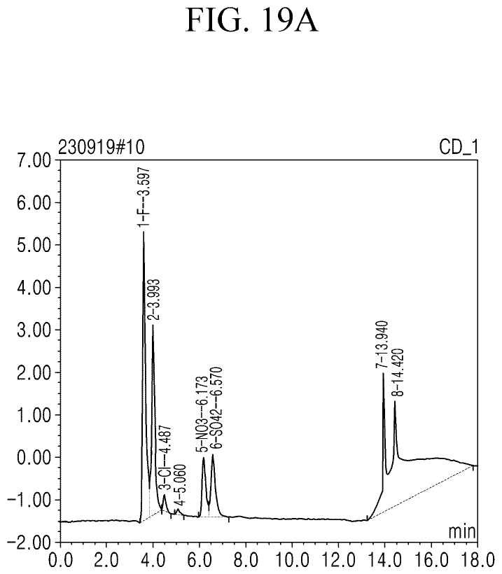

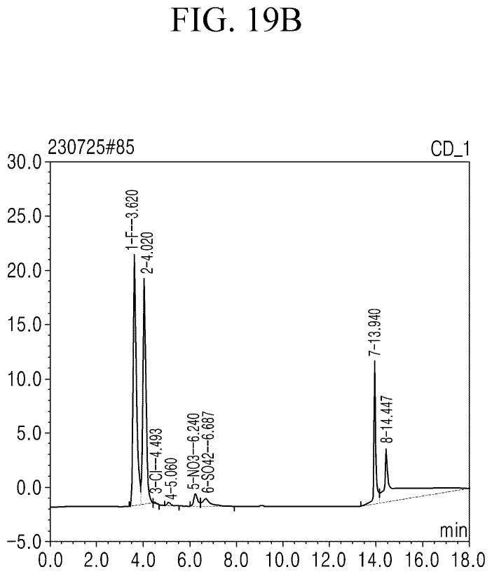

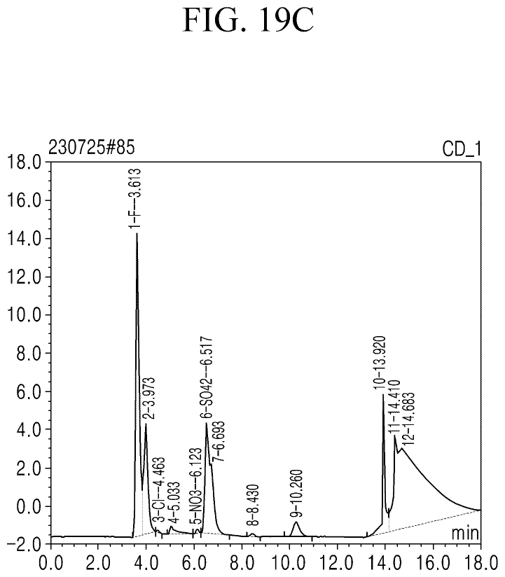

Table 3 and FIGS. 19A-19C show the results after charging and discharging the lithium metal battery cell manufactured through Example 9 during the predetermined cycles, when ion chromatography was performed to measure a residual lithium nitrate amount within the battery cell. The ion chromatography was performed based on a solution obtained by dissociating all the battery components in water after dissembling the battery cell that had been charged and discharged. The analysis results confirmed that as the charge and discharge progressed, the lithium nitrate decreased. Through this, it was confirmed that the supported lithium nitrate was consumed during the battery operation process and thus acted as an additive within the battery cell.

TABLE 3

| | | After | After |
|---|---|---|---|
| | Before | formation | 80th |
| | cycling | cycle | cycle |
| Weight of additive (mg) | 0.21 mg | 0.195 mg | 0.029 mg |
| Ion chromatography result | FIG. 19A | FIG. 19B | FIG. 19C |

7. Results of Lithium Symmetric Cell Evaluation when Applying Polymer Film Supporting Lithium Nitrate

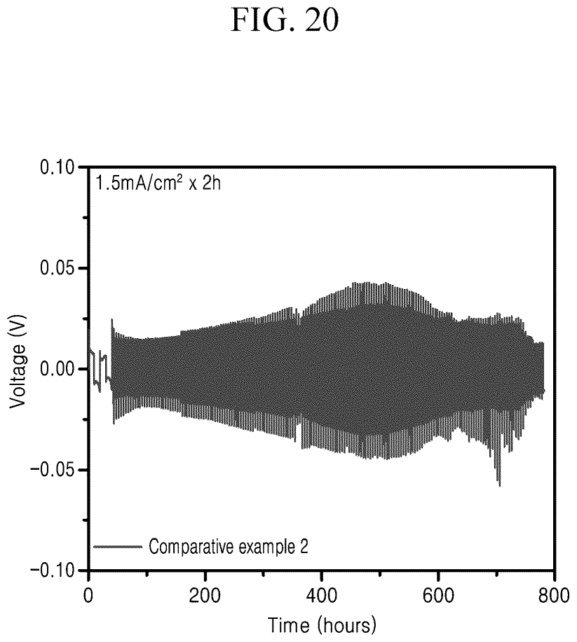

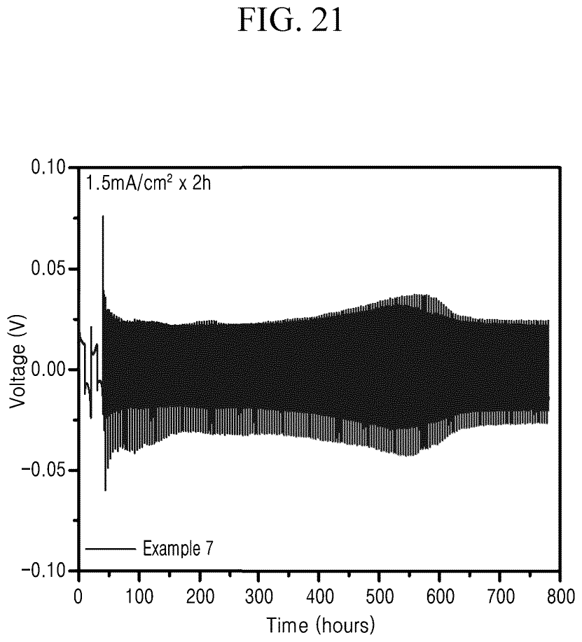

FIGS. 20 and 21 are direct current (DC) polarization curves obtained by alternately applying a current amount of 1.5 mA/cm² for 2 hours to the lithium symmetric battery cells manufactured through Comparative Example 2 and Example 7 to repeat lithium electrodeposition/desorption cycles. When the polymer support film containing lithium nitrate (Example 7) was applied, a more stable cycle was observed than when it was not applied. In particular, the cell of Comparative Example 2 exhibited a short circuit at around 700 hours, but the cell of Example 7 continued stable even after that.

8. Evaluation of Lithium Metal Battery Cycle-Life Characteristics in Carbonate-Based Electrolytes when Polymer Films are Applied.

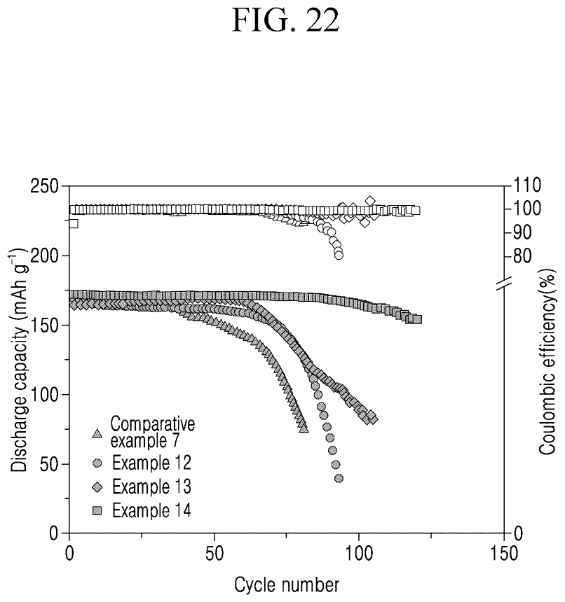

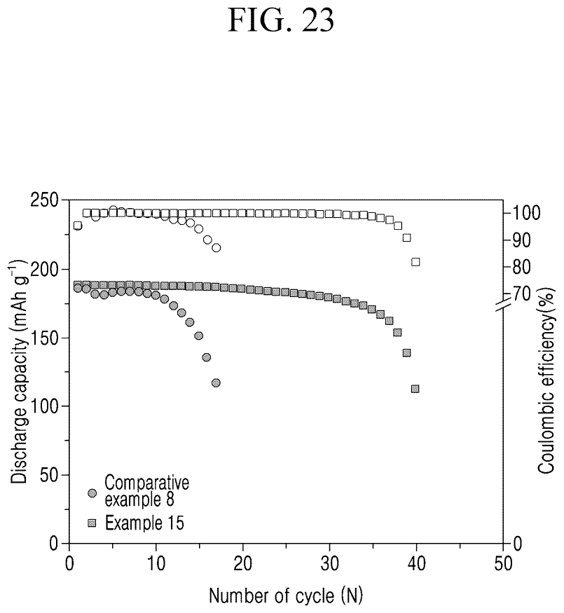

FIGS. 22 and 23 show the evaluation results of the lithium metal battery cells of Comparative Examples 7 and 8 and Examples 12 to 15 by setting a charging and discharging rate at 1.0 C. The following results show that when a polymer support film was applied to a carbonate-based electrolyte for a lithium metal battery and a carbonate-based electrolyte for a conventional lithium ion battery, performance of the lithium-metal battery was improved. Through this, the polymer support film according to an embodiment of the present disclosure was confirmed to be applied not to a specific electrolyte composition but to various electrolyte compositions to improve performance.

In addition, based on confirming that the performance was changed depending on types of additive lithium salts included in the support film, it was confirmed that the performance improvement might be expected even when other additive lithium salts in addition to the lithium nitrate were supported.

9. Evaluation of Lithium Metal Battery Cycle-Life Characteristics in Sulfonamide-Based Electrolytes when Polymer Films are Applied.

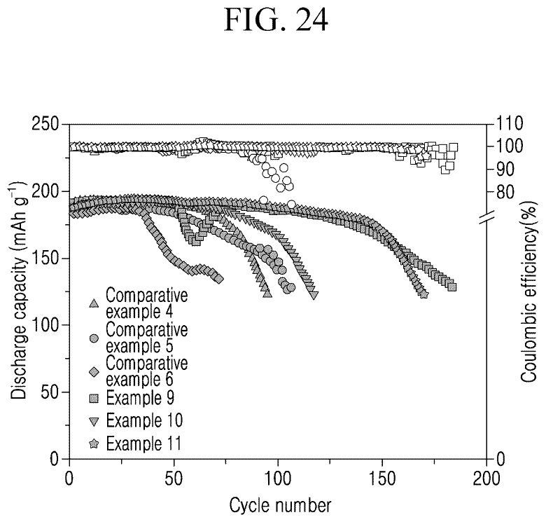

FIG. 24 shows the evaluation results of the lithium metal battery cells of Comparative Examples 4 to 6 and Examples 9 to 11 by setting a charging and discharging rate at 1.0 C. The evaluation was performed by setting a voltage within a range of 3.0 to 4.25 V. Through comparison to Comparative Examples 5 and 6, compared to when lithium nitrate salt was added at maximum solubility of an electrolyte (Comparative Example 5) or when a polymer film alone was used (Comparative Example 6), when the polymer support film according to an embodiment of the present disclosure was applied, it was confirmed that cycle-life characteristics of the battery cells were significantly improved. Accordingly, it was confirmed that the additive lithium salts supported within the polymer support film continuously functioned during the operation of the lithium metal battery cells, thereby improving the cycle-life characteristics.

10. Comparative Evaluation of Cycle-Life Characteristics when a Polymer Support Film is Applied that is not Integrated with the Lithium Metal Negative Electrode.

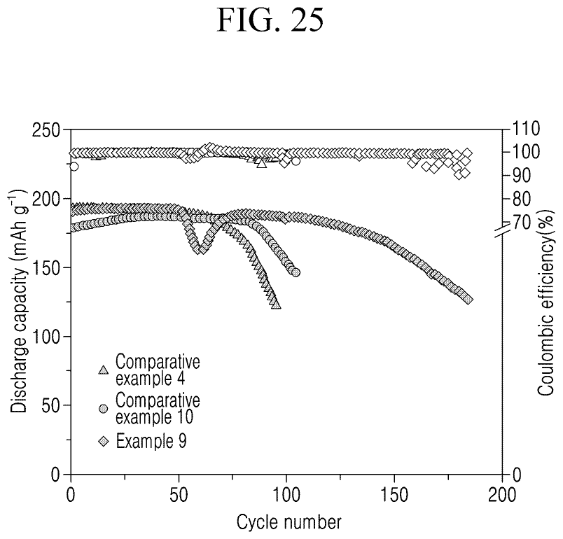

FIG. 25 shows the results of evaluating cycle performance of lithium-metal battery cells according to integration or not of the polymer support film by setting a charging and discharging rate at 1.0 C. The evaluation was performed by setting a voltage within a range of 3.0 to 4.25 V. A support film not integrated with a lithium metal was manufactured to have a thickness of about 7 μm. Comparative Example 10, to which this support film was applied, exhibited high cycle-life characteristics due to elution of lithium nitrate salt, compared to Comparative Example 4, to which the support film was not applied, but a significant decrease in initial capacity due to an increase in interface resistance within the battery cell and thus, significantly lower cycle-life characteristics than Example 9, which used an integrated polymer film. Accordingly, it was confirmed that when a support film was integrated with a lithium metal, excellent cycle-life characteristics was achieved.

Although the embodiments of the present disclosure have been described above, the present disclosure is not limited thereto, and various modifications may be made within the scope of the patent claims, the detailed description of the embodiments, and the attached drawings, which also fall within the scope of the present disclosure.

Accordingly, the substantial scope of the present disclosure is defined by the appended claims and their equivalents.

### DESCRIPTION OF SYMBOL

11 lithium metal battery
12 lithium metal layer as a negative electrode
13 positive electrode
14 separator
15 battery case

What is claimed is:

1. A lithium metal battery, comprising:
a positive electrode;
a lithium metal negative electrode opposite to the positive electrode; and
a separator between the positive electrode and the lithium metal negative electrode;
wherein the lithium metal negative electrode is integrated with a porous polymer support film that supports an additive lithium salt.

2. The lithium metal battery of claim 1, wherein
the additive lithium salt comprises at least one of LiNO₃, lithium difluoro(oxalate)borate (LiDFOB), LiBOB, LiPO₂F₂, LiPF₆, LiBF₄, LiN(SO₂F)₂, LiN(SO₂C₂F₅)₂, LiCF₃SO₃, LiC₄F₉O₃, LiC₆H₅SO₃, LiSCN, LiB(C₂O₄)₂, LiDFOP, or any combination thereof.

3. The lithium metal battery of claim 1, wherein
the porous polymer support film further comprises a polymer, and
the polymer comprises at least one of poly(vinylidene fluoride-hexafluoropropylene) copolymer (PVdF-HFP), polyvinylidene fluoride (PVdF), polytetrafluoroethylene (PTFE), polymethyl methacrylate (PMMA), polyethylene oxide (PEO), polypropylene (PP), polyimide (PI), polyamideimide (PAI), polystyrene (PS), polyvinyl chloride (PVC), polyetheretherketone (PEEK), polyestersulfone (PES), or any combination thereof.

4. The lithium metal battery of claim 1, wherein
the porous polymer support film has a thickness of less than or equal to 5 μm.

5. The lithium metal battery of claim 1, wherein
the additive lithium salt is included in an amount in a range of 2 wt % to 20 wt % based on a total amount (100 wt %) of the porous polymer support film.

6. The lithium metal battery of claim 1, wherein
the lithium metal negative electrode has a thickness in a range of 5 μm to 200 μm.

7. The lithium metal battery of claim 1, wherein
the lithium metal negative electrode integrated with the porous polymer support film that supports the additive lithium salt comprises:
a current collector;
a lithium metal layer on the current collector; and
the porous polymer support film coated on a surface of the lithium metal layer and supporting the additive lithium salt;
wherein the lithium metal layer and the porous polymer support film is integrated.

8. The lithium metal battery of claim 7, wherein
the lithium metal layer has a thickness thicker than the current collector, and
the current collector has a thickness thicker than the porous polymer support film.

9. The lithium metal battery of claim 1, wherein
the additive lithium salt comprises a first additive lithium salt and a second additive lithium salt,
wherein the first additive lithium salt comprises LiNO₃, and
the second additive lithium salt comprises at least one of lithium difluoro(oxalate)borate (LiDFOB), LiBOB, LiPO₂F₂, LiPF₆, LiBF₄, LiN(SO₂F)₂, LiN(SO₂C₂F₅)₂, LiCF₃SO₃, LiC₄F₉O₃, LiC₆H₅SO₃, LiSCN, LiB(C₂O₄)₂, LiDFOP, or any combination thereof, and
wherein the first additive lithium salt is included in a greater amount than the second additive lithium salt.

10. The lithium metal battery of claim 9, wherein
the first additive lithium salt and the second additive lithium salt are included in a weight ratio of 3:1 to 5:1.

11. The lithium metal battery of claim 1, wherein
the positive electrode comprises a positive electrode active material,
the positive electrode active material comprises at least one of LiCoO₂, LiNiₓCo_{y}Mn_{z}O₂ (x, y, and z are each independently real numbers from 0 to 1, where x+y+z=1), LiNiₓCo_{y}Al_{z}O₂ (x, y, and z are each independently real number from 0 to 1, where x+y+z=1), LiFePO₄, sulfur, or any combination thereof.

12. The lithium metal battery of claim 11, wherein
the positive electrode active material comprises LiNiₓCo_{y}Mn_{z}O₂ (x, y, and z are each independently real numbers from 0 to 1, 0.8≤x<1, x+y+z=1), LiNiₓCo_{y}Al_{z}O₂ (x, y, and z are each independently real numbers from 0 to 1, 0.8≤x<1, x+y+z=1), or a combination thereof.

13. A method for producing lithium metal integrated with a porous polymer support film that supports an additive lithium salt, the method comprising
mixing an organic solvent, a polymer, and an additive lithium salt to obtain a polymer solution;
coating the polymer solution on a lithium metal surface; and
drying the polymer solution coated on the lithium metal surface.

14. The method of claim 13, wherein
the additive lithium salt comprises at least one of LiNO₃, lithium difluoro(oxalate)borate (LiDFOB), LiBOB, LiPO₂F₂, LiPF₆, LiBF₄, LiN(SO₂F)₂, LiN(SO₂C₂F₅)₂, LiCF₃SO₃, LiC₄F₉O₃, LiC₆H₅SO₃, LiSCN, LiB(C₂O₄)₂, LiDFOP, or any combination thereof.

15. The method of claim 13, wherein
the porous polymer support film further comprises a polymer, and
the polymer comprises at least one of poly(vinylidene fluoride-hexafluoropropylene) copolymer (PVdF-HFP), polyvinylidene fluoride (PVdF), polytetrafluoroethylene (PTFE), polymethyl methacrylate (PMMA), polyethylene oxide (PEO), polypropylene (PP), polyimide (PI), polyamideimide (PAI), polystyrene (PS), polyvinyl chloride (PVC), polyetheretherketone (PEEK), polyestersulfone (PES), or any combination thereof.

16. The method of claim 13, wherein
the additive lithium salt is included in an amount in a range of 2 wt % to 20 wt % based on a total amount (100 wt %) of the polymer solution.

17. The method of claim 13, wherein
the additive lithium salt comprises a first additive lithium salt and a second additive lithium salt,
wherein the first additive lithium salt comprises LiNO₃, and
the second additive lithium salt comprises at least one of lithium difluoro(oxalate)borate (LiDFOB), LiBOB, LiPO₂F₂, LiPF₆, LiBF₄, LiN(SO₂F)₂, LiN(SO₂C₂F₅)₂, LiCF₃SO₃, LiC₄F₉O₃, LiC₆H₅SO₃, LiSCN, LiB(C₂O₄)₂, LiDFOP, or any combination thereof, and
wherein the first additive lithium salt is included in a greater amount than the second additive lithium salt.

18. The method of claim 17, wherein
the first additive lithium salt and second additive lithium salt are included in a weight ratio of 3:1 to 5:1.

19. The method of claim 13, wherein
the organic solvent and additive lithium salt are included in a weight ratio of 1:1.

20. The method of claim 13, wherein
mixing the organic solvent, the polymer, and the additive lithium salt is performed at a temperature in a range of 30 °C to 50 °C, and
drying the polymer solution coated on the lithium metal surface is performed at a temperature in a range of 80 °C to 100 °C under a vacuum condition for 6 to 24 hours.
